(19) United States
(12) Patent Application Publication
(10) Pub. No.: US 2024/0219598 A1
(43) Pub. Date: Jul. 4, 2024

(54) Modular System and Marine Seismic Monitoring Method by Permanent Point Receivers, Support-Pile Module, Telescopic-Type Pile, Method of Burying and Method of Unearthing of the Telescopic-Type Pile

(71) Applicant: PETRÓLEO BRASILEIRO S.A. - PETROBRAS, Rio de Janeiro (BR)

(72) Inventors: Jorge Fiori Fernandes Sobreira, Rio de Janeiro (BR); Carlos Eduardo Borges De Salles Abreu, Rio de Janeiro (BR); Ney Robinson Salvi Dos Reis, Rio de Janeiro (BR); Remo Zauli Machado Filho, Rio de Janeiro (BR); Cláudio Dos Santos Amaral, Rio de Janeiro (BR); Robert Eisemberg, Rio de Janeiro (BR)

(21) Appl. No.: 18/400,903

(22) Filed: Dec. 29, 2023

(30) Foreign Application Priority Data
Dec. 29, 2022 (BR) 10 2022 026994 7

(51) Int. Cl. G01V 1/38; G01V 1/18

(52) U.S. Cl. CPC G01V 1/3843; G01V 1/18; G01V 2210/1427

(57) ABSTRACT

In a first aspect, a Torpedo-type Support-Pile Module (SPM) is disclosed, which includes a panel for wet connection, a burial restrictor device, and a base jointly mounted to a Seismic Sensor Module (SSM), which houses a combination of a pressure sensor with particle velocity or particle acceleration sensors, in addition to inclination sensors. In a second aspect, a telescopic-type SPM is disclosed, which includes a panel for wet connection, a base jointly mounted to a SSM, and at least two cylindrical sections capable of being inserted into each other, thereby reducing the storage and transport volume of the SPM. The panel of any one of the SPMs is connected to a wet connector of a Subsea Seismic Data Acquisition Module (SSDAM), the SSDAM in turn providing power to the seismic sensors of the SSM during the seismic data capture. At the end of the capture, the seismic sensors send the acquired data to a memory located in the SSDAM, and the connection between the panel and the connector is finally disconnected. Also disclosed are seismic data acquisition methods and a seismic survey system, for the purposes of permanent marine seismic monitoring related to SPMs. Advantageously, this methodology has the possibility of applying part of the logistics described above in reverse, so that, at the end of the seismic data acquisition campaigns or even when convenient, the telescopic-type SPMs can be removed, freeing the seabed of such items and leaving the same as it was before installation.

### RELATED APPLICATIONS

This application claims the benefit of Brazilian Patent Application No. BR 10 2022 026994 7, filed Dec. 29, 2022, the entire contents of which are explicitly incorporated by reference herein.

### FIELD

The present invention falls within the field of subsea seismic monitoring. More specifically, the present invention relates to systems, devices and methods for seismic monitoring with a high degree of seismic repeatability.

### BACKGROUND

In conventional marine seismic activity, an acoustic source generally consisting of air cannons towed close to the water surface by a dedicated vessel, emits high-energy sound signals, which propagate through the water column towards the bottom, penetrating in the marine substrate, being partially reflected and/or transmitted to each interface separating different sedimentary layers. The reflected signals propagate upwards, through the layers, subsequently crossing the water column, and are finally captured by several pressure sensors (receivers) (hydrophones) installed on one or more floating seismic cables. These cables, called streamers, are typically several kilometers long, and are also towed close to the water surface by the same vessel.

One of the main production management tools for oil field reservoirs involves seismic monitoring, conducted throughout the period of concession of the area to the Operator. This technology presupposes successive seismic surveys carried out over time (the so-called 4D Seismic), with the differences observed in the interpreted data being related to variations in properties such as fluid saturation, pressure and rock compaction. The greatest effectiveness of this technology presupposes carrying out surveys with the same geometry and data acquisition apparatus, as well as carrying out shots and receiving signals by the sensors in geographical positions identical to those of previous surveys, with strict repeatability parameters, i.e., reproducibility of the conditions of the previous survey.

Reservoirs producing geologically complex hydrocarbons, very deep and with little variation in elastic geophysical parameters, in response to production and/or injection, tend to present reduced detectability of the signals corresponding to the properties of interest by 4D Seismic, especially in its conventional modality (Surface Seismic). In these cases, it becomes necessary to maximize the repeatability of the seismic survey, both by the invariability, throughout subsequent campaigns, of the positions of the sources and seismic sensors, and by the consistent (and optimal) coupling of the sensors with the substrate, and, preferentially, by minimizing the level of noise, undesirable for seismic recording. Repeatability is more critical the more subtle the 4D seismic signal of interest or the lower its detectability.

The development of production and exploitation of the oil fields involves the installation of complex production and fluid flow systems, both on the surface and in the water column and on the seabed, which include: manifolds, interconnection bases (plets), flow lines (horizontal and risers), pipes, buoys, fixed and floating platforms and anchoring lines and devices. This infrastructure imposes serious limitations on seismic data acquisition activities in production areas, given the strict operational safety criteria that must be observed when vessels towing receiving cables and seismic sources pass in their vicinity. These oil installations represent operational obstacles to seismic surveys, limiting the free access of seismic vessels and imposing restrictions on the repeatability, and, therefore, on the final quality of the seismic data recorded for production monitoring purposes.

To try to overcome these difficulties, since the 90s, seismic data acquisition systems have emerged, widely described in the literature, based on receivers placed on the seabed, namely: Ocean Bottom Cables (OBCs) and Ocean Bottom Nodes (OBNs). In OBCs, the receivers are interconnected sequentially along a cable, whose upper end is connected to a vessel or a production platform for the purpose of transmitting recorded data and supplying energy. In OBNs, the point receivers have autonomous recording capacity, but the continuous operation time is limited by the useful life of the batteries stored inside the same. Each block of receivers employed, in both modalities, is multicomponent, that is, each one made up of particle velocity sensors (geophones) or, alternatively, of particle acceleration sensors (accelerometers) invariably triaxial, that is, presenting three components, and co-located with a hydrophone, in turn a pressure sensor, making a total of 4 recording components in each set of receivers.

An advance in relation to increasing repeatability in 4D seismic surveys can be obtained by implementing OBCs as a Permanent Seismic Monitoring System (PSMS), in which case the position of the cables remains invariable on the seabed; for this, it is necessary that are permanently connected to a production platform. For OBNs, the current stage of technological development does not yet allow similar implementation as PSMS.

Among the benefits provided by placing seismic receivers on the seabed, we can mention the absence of energy loss due to the propagation of signals reflected upwards through the water column (notably in deep and ultra-deep waters) and the possibility of properties related to the seismic wave field are measured, not only of an acoustic nature (such as pressure) but also of an elastic nature (such as the particle velocity or acceleration).

The marine substrate, particularly for deep and ultra-deep water conditions, is typically unconsolidated (i.e., formed by soft sediments), with high porosities and pore water saturations. These characteristics tend to contribute to the degradation of the quality of seismic data obtained with seabed receivers, such as OBNs, due to: i) the sub-optimal coupling of sensors placed on the seabed; ii) resonance effects and the presence of noise in the horizontal components due to undesirable movements; iii) noise radiated by subsea production equipment; and iv) noise and movements associated with bottom sea currents.

The OBCs and OBNs potentially present advantages in terms of accuracy and positional repeatability in relation to floating receiver cables (streamers), since they are less exposed to the surface drift of the cables, imposed by sea currents. However, the OBCs, even if employed as PSMSs, may face operational difficulties in ultra-deepwater areas and complex bottom obstructions related to subsea production facilities, such as wells, pipes, umbilicals, manifolds, pumps, separators, and anchor lines for surface installations. On the other hand, the OBNs tend to be less sensitive to the presence of obstructions and higher water depths, as they were developed to avoid the need for interconnection via a cable. However, the need for installation and subsequent removal from the seabed by remotely operated vehicles (ROVs) immediately after each survey, due to the large number of units to be installed and the life limitations (autonomy) of the batteries, tends to imply higher operating costs.

In Marine Seismic, ultra-short baseline acoustic positioning methods are generally used, with an error proportional to the water depth, which causes positional inaccuracy (high variance) and consequent loss of repeatability, especially in ultra-deep water fields (more than 2000 m of water depth). When using bottom point sensors, although undesirable, an installation outside the project location requirements would be acceptable, given the existence of subsea obstructions, as long as the determination of this effective position is made with low variance.

The two Bottom Seismic methods described above make use of the arrangement of sensors on the substrate, generally soft, of the seabed, which present sub-optimal coupling in relation to the signals of interest that are propagating through the underlying sediments, which contributes to the capture of noise, resulting, in many cases, in seismic images of insufficient coherence and repeatability, which are fundamental attributes or characteristics for use in the management and seismic monitoring of reservoirs.

### STATE OF THE ART

The US patent publication application dated Jan. 27, 2009, US 2009/0238647 A1, titled “METHOD FOR COUPLING SEISMOMETERS AND SEISMIC SOURCES TO THE OCEAN FLOOR”, inventors DELFINO, Neil Ernest; RONEN, Joshua; VU, Cung Khac, discloses the installation of suction piles on the seabed and then the fixing of seismic sensors inside the same. The suction pile is a well-known concept for driving piles in very shallow waters, wherein the lower, open tip of the pile is placed vertically on the seabed, and according to which pumps located on the installation vessel remove the internal water, through the upper, closed tip, causing the pressure differential and the weight of the water column to bury the pile in the shallow sediment. This application does not clarify, however, how the sediment inside the pile is removed to allow the sensors to be installed, since the piling method presupposes that the lower end of the pile is opened, allowing sediment from the seabed to penetrate the same, making the use of suction piles as a method of burial in the manner thus conceived questionable. In the past, the use of the concept of suction piles for use as anchoring points for floating oil production units in deep waters was attempted, however, encountering implementation difficulties due to the need to install pumps on the pile itself, and the need for the pumps to operate under the high external hydrostatic pressure of the seabed. Such a contextualization illustrates that the use of suction piles must be done on a judicious basis, especially in the case of burying hundreds to thousands of seismic sensors in ultra-deep waters.

The application for Privilege of Invention filed on Aug. 30, 1996, BR PI 9603599-4, titled “ESTACA PARA ANCORAGEM DE ESTRUTURAS FLUTUANTES E SEU PROCESSO DE INSTALAçÃO” (PILE FOR ANCHORING FLOATING STRUCTURES AND ITS INSTALLATION PROCESS), inventors MEDEIROS JUNIOR, Cipriano José; HASSUI, Luiz Hissashi; MACHADO, Rogério Diniz, refers to the pile called Torpedo, which was the solution found for installing anchor piles for floating production units in deep and ultra-deep waters in a viable and quick way, at least in areas with the seabed unobstructed. Associated with the application for Invention Privilege filed on Dec. 21, 2004, BR PI 0405799-6, titled “ESTACA TORPEDO COM PODER DE GARRA AUMENTADO PARA A ANCORAGEM DE ESTRUTURAS FLUTUANTES E MÉTODO DE INSTALAçÃO” (TORPEDO PILE WITH INCREASED CLAW POWER FOR ANCHORING FLOATING STRUCTURES AND INSTALLATION METHOD), inventors MEDEIROS JUNIOR, Cipriano José; CARVALHO, Luiz Fernando, refers to a pile specially designed for the local geotechnical conditions of the marine substrate, with the appropriate shape and weight to allow it to be released in free fall from a convenient height in relation to the seabed, and acquire enough kinetic energy to fully penetrate the marine substrate, but leaving a section of moorings on the bottom, such that it can be connected to the anchor lines. Piles of this type are routinely used, measuring more than 15 m in length and weighing more than 100 tons, to anchor production units in ultra-deep waters in the Campos, Santos and Espirito Santo basins. Methods have been developed that allow this type of pile to be piled with an accuracy of the order of a few meters in relation to the desired position, which, however, tends to require improvements of one or two orders of magnitude, in the case where such piles need to be piled close to already installed bottom infrastructure, such as pipes, for example, in order to preserve their integrity.

The application for Privilege of Invention filed on Sep. 29, 2004, BR PI 0404168-2 A2 titled “DISPOSITIVO PARA INVESTIGAçÃO GEOTÉCNICA IN SITU EM SOLO MARINHO” (DEVICE FOR IN SITU GEOTECHNICAL INVESTIGATION IN MARINE SOIL), inventors MEDEIROS JÚNIOR, Cipriano Jose; PORTO, Elizabeth Campos; AMARAL, Cláudio Santos; MACHADO FILHO, Zauli; Remo FERREIRA, Antonio Carlos Pimentel, shows another application of the torpedo pile concept, using a short pile, carrying sensors in its lower cone, in this case to allow the determination of the geotechnical properties of the marine substrate.

Piles of the types described above, when instrumented by sensors, require an internal battery to power the components, which, however, has a limited useful life, such that it needs to be recharged or replaced periodically, which results in in additional operating costs.

Therefore, the technique lacks methods and systems applied to 4D Seismic of the seabed capable of allowing the maximization of the 4D detectability through the optimal and consistent coupling of sensors to the sediments, greater attenuation of environmental noise, and greater positional repeatability.

The technique also lacks an PSMS applicable to deep and ultra-deep waters with high bottom infrastructure complexity.

### SUMMARY

The present invention proposes the use of support-pile modules (SPM), whether of the Torpedo type, but of much shorter length than those used for anchoring marine structures, to be released in free fall in the column water (when there is no pre-existing infrastructure near the desired point on the seabed, whose integrity needs to be preserved) or of the telescopic type, buried by an external device, and with fine positioning control (when the seabed is obstructed or when it is environmentally sensitive). For both types of SPM, a permanent burial of point seismic sensors is thus obtained, part of an associated seismic data acquisition system, guaranteeing high repeatability and 4D seismic detectability through the optimal and consistent coupling of the sensors to the sediments, of the greatest and most consistent attenuation of the environmental noise, and high positional invariability, also incorporating the advantages of using point receivers, which include better seismic quality and greater operational flexibility with regard to implementation as systems permanent with high repeatability, as described in detail and claimed below.

The method applies to the permanent burial of seismic sensors in the shallow marine substrate, through two previously mentioned technological routes, namely: torpedo-type support-pile modules (SPM) and telescopic-type SPM, which can be buried by external mechanism and with fine positioning control, and both with the purpose of increasing repeatability, as an essential requirement for the success of seismic surveys repeated over time, a technology known in the Petroleum Industry as 4D Seismic or Time Lapse Seismic. Additionally, the aforementioned burial tends to promote the improvement of the intrinsic quality of the seismic data acquired in successive surveys, base and monitors. This benefit is provided both by improving the coupling of the receivers with the environment (in this case, the sediments that make up the shallow marine substrate) and by the greater attenuation of surface environmental noise in relation to usual seabed receiver systems. Said method allows the design of a system for permanent seismic monitoring of oil fields under production, through the use of point seismic receivers on the seabed, similar to Ocean Bottom Nodes (OBNs), but without their inherent limitations. The described method and system can be applied in aquatic environments, especially marine ones, being functional even in areas with a seabed obstructed by oil installations or environmentally sensitive, and in waters of any depth, including ultra-deep waters.

The System provides for the fixation of seismic sensors jointly to the lower end of a torpedo-type or telescopic-type SPM. In the first case, the torpedo-type SPM is released from pre-determined depths in the water mass, from then on assuming a free-fall movement, which allows the assembly to be buried in the shallow marine substrate. The torpedo-type SPM is designed to be piled into such a substrate, thus placing the seismic sensors in contact with the surrounding sediment, and further contains penetration restrictors, which ensure that its upper part is at a convenient height above the seabed. In the second case (telescopic-type SPM), and to meet sensitive scenarios and obstructed or congested seabeds, a telescopic-type SPM burial method is proposed based on an active external mechanism, and with refined positioning control, which operates as an accessory to a used ROV. For both the torpedo-type SPM and the telescopic-type SPM, the upper end of the SPM features connectors that can be connected externally, with the aid of a subsea vehicle, preferably an ROV, to allow communication and the supply of electrical energy to the sensors located at the lower end of the SPM. Optionally, an Autonomous Underwater Vehicle (AUV) or other suitable equipment may be used for this connection operation.

This assembly, which is now permanently installed on the seabed, must be subsequently connected, with the help of the ROV, to an exposed, replaceable module, and removed after each survey, which contains the storage functions of the recorded seismic data and supply of electrical energy using its own batteries, in addition to providing a time reference via a clock for temporal synchronization.

### BRIEF DESCRIPTION OF THE DRAWINGS

The present invention will be described below with reference to typical embodiments thereof and with reference to the attached drawings, which will be divided by family/function.

FIGS. 1 to 3: Support-Pile Module (SPM) and basal cone that contains the sensors (Seismic Sensors Module), joint.

FIG. 1 is a representation, in the form of an overview, of the torpedo-type Support-Pile Module (SPM), joint to the Seismic Sensor Module (SSM), according to a first embodiment of the present invention.

FIG. 2 is a representation, in the form of an overview, of the telescopic-type Support-Pile Module (SPM), joint to the Seismic Sensor Module (SSM), according to a second embodiment of the present invention.

FIG. 3 is a representation of the basal cone constituting the Seismic Sensor Module (SSM), according to the present invention.

FIGS. 4 to 7: Subsea Seismic Data Acquisition Module, Positioning and Alignment Module, and interaction and operation via ROV.

FIG. 4 is a representation of the Subsea Seismic Data Acquisition Module (SSDAM), according to the present invention.

FIG. 5 is a representation of the Positioning and Alignment Module (PAM), according to the present invention.

FIG. 6 is a representation of an ROV inserting the PAM into the torpedo-type or telescopic-type SPM aligned support, according to the present invention.

FIG. 7 is a representation of a remotely operated vehicle (ROV) performing the wet connection between the SSDAM and the torpedo-type or telescopic-type SPM, in accordance with the present invention.

FIGS. 8 to 9: Pile Transport and Release Device and Auxiliary Subsea Control Mechanism, used exclusively for the torpedo-type SPMs:

FIG. 8 is a representation of the Pile Transport and Release Device (PTRD), according to the present invention.

FIG. 9 is a representation of the Subsea Auxiliary Control Mechanism, accessory to the Piles Transport and Release Device, according to the present invention.

FIG. 10: Telescopic-type SPM in different configurations.

FIG. 10 is a representation of a schematic cross-section, showing different configurations of the telescopic-type SPM, according to the present invention.

FIG. 11: Schematics of a telescopic-type SPM unit and the basic configurations it can assume.

FIG. 11 is a representation of the telescopic-type SPM in its two basic configurations, according to the present invention.

FIGS. 12 to 14: Telescopic-type SPMs, positioned with precision control of the ROV and apparatus for transporting and burying the SPMs.

FIG. 12 is a representation of the telescopic-type SPM being extended from its compacted configuration, through handling by the ROV, in accordance with the present invention.

FIG. 13 is a representation of an auxiliary device adaptable to an ROV, to assist in the installation/burying of the telescopic-type SPM, according to the present invention.

FIG. 14 is a representation of the auxiliary device coupled to an ROV, loaded with telescopic-type SPM in its compacted configuration, in accordance with the present invention.

### DETAILED DESCRIPTION

### 1. Modular Marine Seismic Monitoring System Using Permanent Point Receivers

The Marine Permanent Seismic Monitoring System (PSMS) based on point receivers proposed herein is modular, in the sense that it consists of different modules, in a total of four, all operating in subsea conditions, each with a very specific function, although complementary to each other, and employed in different operational steps of the seismic monitoring project, namely: Support-Pile Module (SPM), Seismic Sensor Module (SSM), Subsea Seismic Data Acquisition Module (SSDAM) and Positioning and Alignment Module (PAM), the latter being optional, although preferred. In this sense, the proposed modular system essentially differs from OBNs, which correspond to integrated receiving units (“all in one”), by allowing its configuration in two main parts: one permanently installed and the other not permanently installed, which entails advantages from the point of view of enabling its use as a truly permanent seismic monitoring system. The System is externally complemented by a Surface Control Module (SCM), not detailed, which corresponds to a non-submerged part, which remains on board the support vessel during the seismic data survey, and which, despite the name, corresponds in fact to a set of equipment and/or onboard facilities, including means of acoustic communication, means of recharging batteries and means of downloading seismic data recorded during the acquisition campaign.

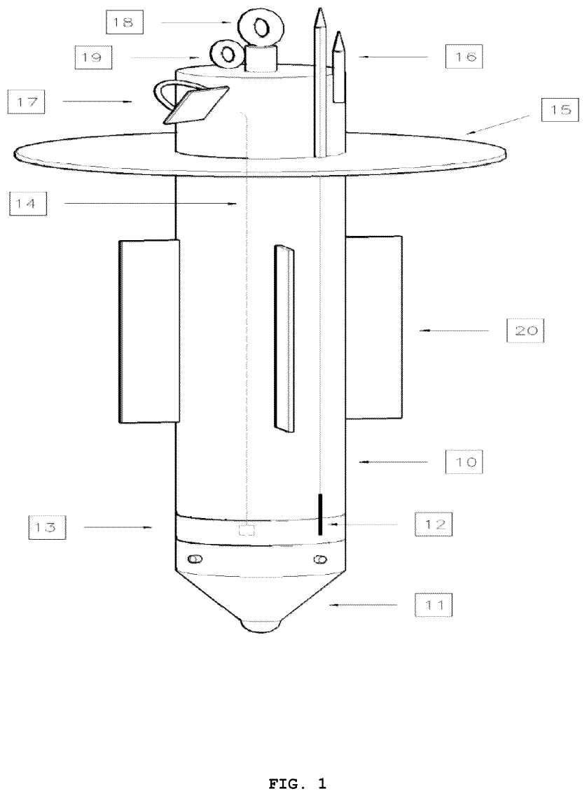

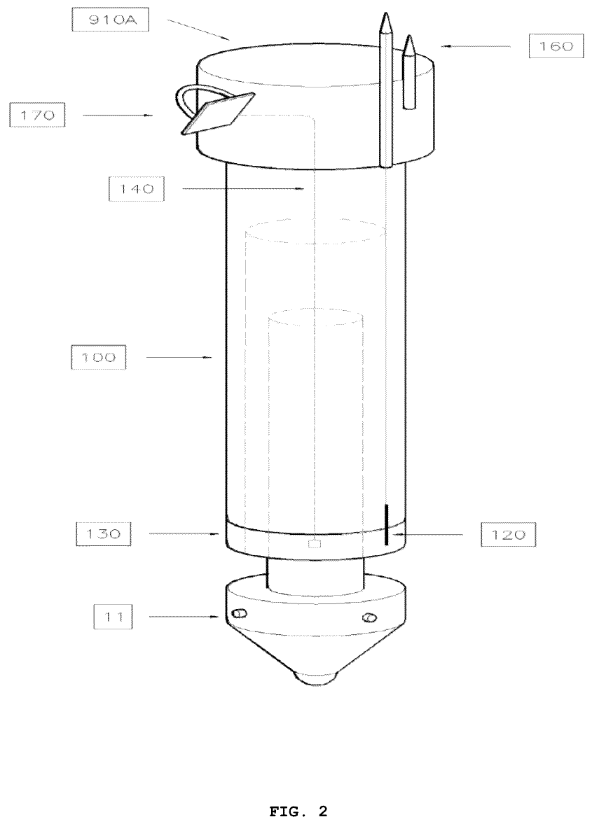

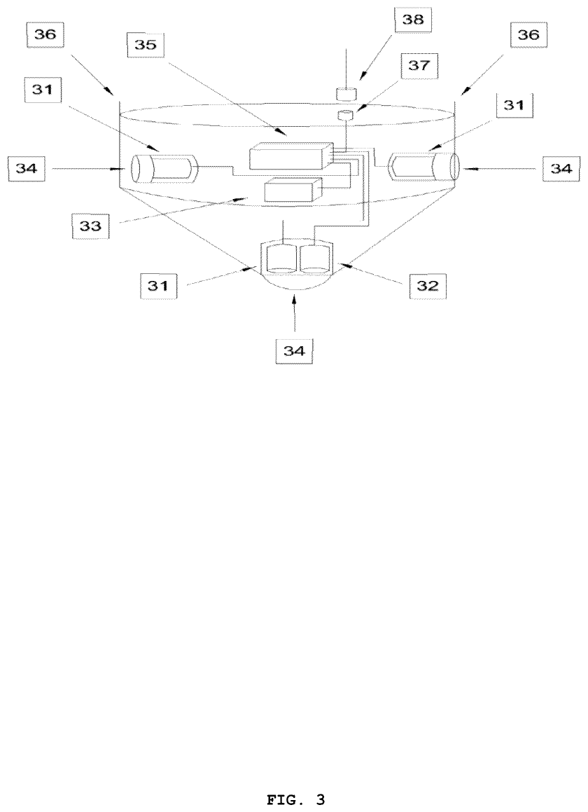

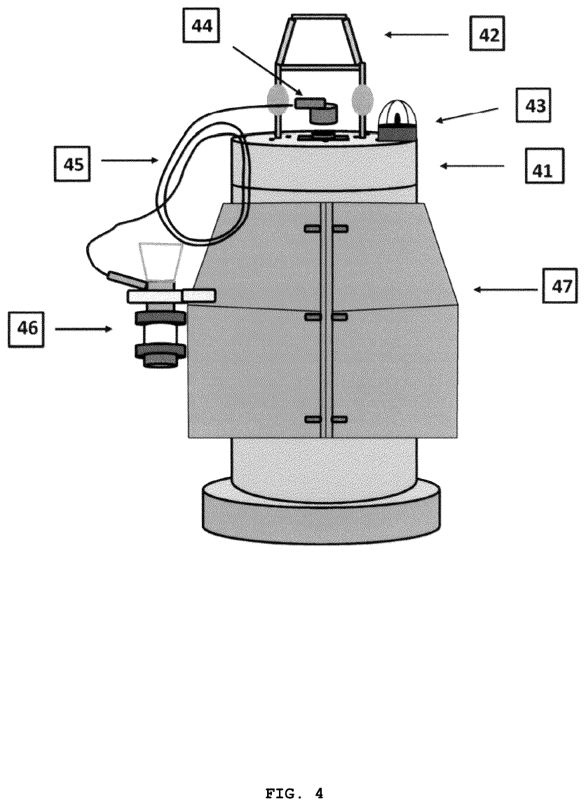

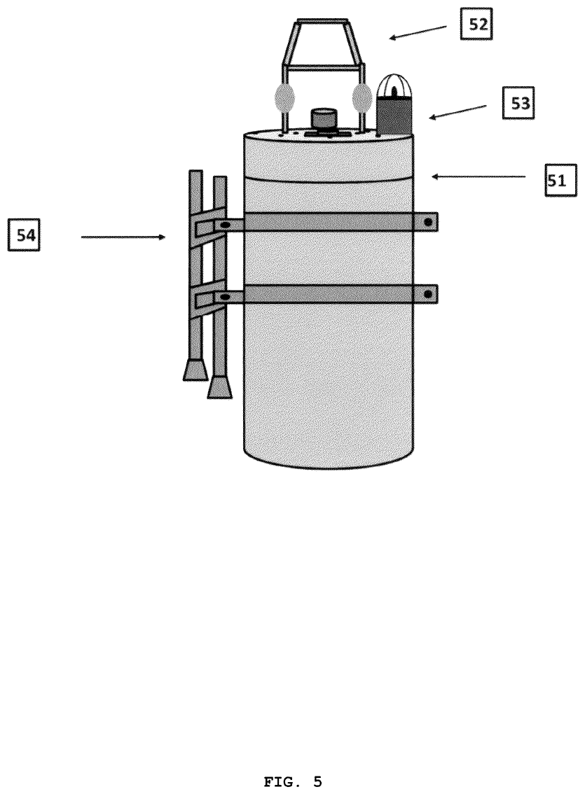

A first aspect of the invention is related to a permanent seismic monitoring system, arranged in multiple locations on the seabed, each corresponding to a Seismic Acquisition Station (EAS). Each EAS has a permanent part, consisting of the Seismic Sensor Module (SSM, FIG. 3) and the Support-Pile Module (SPM), which can correspond to a Torpedo-type pile (FIG. 1) or a Telescopic-type pile (FIG. 2), modules that are integral with each other, and a non-permanent part, consisting of the Subsea Seismic Data Acquisition Module (SSDAM, FIG. 4), reinstalled with each new seismic survey, and the Positioning and Alignment Module (PAM, FIG. 5), also non-permanent, optionally used, and, in this case, only once throughout the entire seismic monitoring project, preferably in the period between the installation of the SPMs and the initial (baseline) seismic survey. The System is externally complemented by a Surface Control Module (SCM), which corresponds to a non-submerged part, which remains on board the support vessel during the seismic data survey. The existence of sensor modules permanently installed on the marine substrate, a feature of this invention, essentially differs from conventional Ocean Bottom Nodes, which bring together all their parts (sensors and subsea electronics) in the same unit (all in one), which is collected at the end of each seismic survey, and whose sensors are not buried or only very superficially. In a different way, the proposed system is modular, in the sense that it contains parts that are originally tight, but that can be coupled when necessary, with the part that contains the sensors being able to remain permanently installed (buried) in the marine substrate, while the part that contains the batteries, recorded data memory, and time synchronization clock is installed (i.e., connected to the permanent part), and then uninstalled (i.e., disconnected from the permanent part) after each repeated seismic survey.

A second aspect of the invention is related to a telescopic-type SPM, with precision burial, based on a controlled and active mechanism, with operation and installation by subsea vehicles, for example, an ROV, wherein the device that helps to carry out such procedures is called “Cartridge”. In this sense, considering that the sensor network must cover large extensions of the seabed, not always free from operational obstacles and insurmountable interferences, this aspect is related to a sensor installation system that makes it possible to operate safely in areas that present risk or operational complexity, namely, where there are already facilities in operation, such as flow pipes and other production equipment, or where there is environmental interest and sensitivity, such as regions with the presence of corals or rhodoliths.

Accordingly, two types of SPMs can be used, depending on the condition and nature of the seabed: torpedo-type SPM 10 (FIG. 1) and telescopic-type SPM 100 (FIG. 2), which, although having some common constituent elements differ in terms of the incorporation of specific elements, constituent materials and installation mode. It is estimated that, in general, the areas subject to seismic monitoring projects will do without the availability of both types of SPMS, and the associated infrastructure necessary for their handling and operation.

### 1.1 Support-Pile Module (SPM)

Referring to FIGS. 1 and 2, the Support-Pile Module (SPM) 10, 100, according to the first aspect of the present invention, comprises a pile, which is partially buried in the marine substrate, and which, depending on the condition of the marine soil and the way it is installed and piled in the substrate, it can be of the Torpedo type or Telescopic type. The SPM 10 of the torpedo type 10 (FIG. 1), as it is installed using a free fall movement after its release at a determined height in relation to the seabed, is made of material resistant to the impact of being piled into the marine soil and to the exposure to sea water for long periods, as well as to the pressure. For example, and without limitation, this material may be stainless steel. The SPM 10 based on the Torpedo-type pile is designed in shape and weight to allow it to be piled to the desired depth in the marine substrate after descending in a free-fall motion. On the other hand, the telescopic-type SPM 100 (FIG. 2), due to the fact that it is installed and buried in a controlled manner, with the aid of a vehicle, such as an ROV, can be manufactured with lighter material, although equally resistant to the exposure to the sea water for long periods, as well as to the pressure. For example, and without limitation, this material may be based on light alloy metals, polymeric composition items, carbon fiber or engineering plastics such as acetal.

The SPM 10, 100 is jointly connected to the Seismic Sensor Module (SSM) 11 at its lower end. According to the present invention, the lower part or end of the SPM 10, 100 is the end that is attached to the basal cone represented by the SSM 11, and which is buried in the marine substrate. In turn, the upper part or end is the end that sticks out of the seabed, that is, it is not buried.

### 1.1.1 Torpedo Type Support-Pile Module

The SPM 10 for the Torpedo pile (FIG. 1) contains, at its lower end, an alignment marker 12 and an undesirable noise (vibration) attenuation device 13, which is close to the interface with the SSM 11 The SPM 10 also has a burial restrictor device 15 (which is not incorporated into the telescopic-type SPM 100 as it is useless in this case), located near the top of the SPM 10, to ensure that it remains at the desired height above the seabed, avoiding burial beyond the desired depth. The burial restrictor device preferably takes the shape of a disk, concentric to the SPM 10. This shape is convenient for temporarily supporting the SSDAM 41, as will be detailed below; however, this burial restrictor device 15 can assume any other shape capable of performing the function of ensuring that the SPM 10 is buried in the intended manner, not limited to the shape of a hollow disk.

Fins 20, lateral to the body of the SPM 10, are optional elements to assist in the stabilization and verticalization of the SPM 10 throughout its downward movement, being dispensable in the case of the SPM 100 (of the Telescopic-type), which is buried in loco with the aid of a subsea vehicle, for example an ROV.

The SPM 10 also has an intervention panel 17 preferably by ROV, at its upper end, which contains connectors suitable for connection by ROV, parking positions for connector covers and ROV anchoring devices, in addition to internal electrical cabling 14, which connects the panel 17 to the SSM 11, and further a support and alignment device 16 for equipment such as the Positioning and Alignment Module (PAM). For simplicity, the present description assumes that the subsea support vehicle is an ROV, although it is not limited in such a way.

Additional elements exclusive to the SPM 10 are the lifting eye 18 and the supporting eye 19, the function of which will be explained later. Such elements are absent in the SPM 100 (of Telescopic-type) as they are of no use.

Alternative configurations, including the use of other devices to assist in the installation and use of the SPMs described herein, are possible, without departing from the scope of the present invention. Such variations will be readily realized by the technician skilled on the subject for specific applications.

### 1.1.1.1 Burial Method of the Torpedo-Type SPM

Once assembled on the structure of the Pile Transport and Release Device (PTRD) 81, intended for transportation, from the support vessel to the water column, at the desired height in relation to the seabed, as described in detail below, the torpedo-type SPMs 10 are released through an acoustic command from the surface, when they begin to assume a free-fall movement in the water column until they reach the seabed with enough kinetic energy to allow the torpedo-type SPMs 10 to be piled in the shallow marine substrate, to which their own weight and shape contribute. Optionally, the SPM 10 may contain side fins 20 to assist in maintaining the most vertical trajectory possible to the seabed. Any over-burial of the SPM 10 beyond what is desired is prevented by incorporating, into the SPM 10, the burial restrictor device 15.

This process of installing the SPM 10 begins with the positioning of the support vessel on the pre-defined coordinate point, where a certain SPM 10 will be installed. Depending on the depth to the seabed, and since the PTRD 81 is capable of transporting up to nine SPM 10 in each descent operation, it may be more advantageous in terms of productivity to keep the PTRD 81 submerged while the vessel heads to the next installation position. After installing all the SPMs 10 transported on the PTRD 81, it is winched back to the vessel, and a new installation procedure begins, at another pre-determined point, always under the guidance of acoustic measurements between the PTRD 81 and the vessel, until all the SPMs 10, planned to be used during the seismic survey, are installed.

The torpedo-type SPMs 10 are installed in the marine substrate using the same procedure used for piling torpedo piles, used as foundations for oil structures, from their release into the water column and adoption of movement in free fall, as is known in the art.

### 1.1.2 Telescopic-Type Support-Pile Module

The SPM 100 related to the Telescopic pile (FIG. 2) has, at its lower end, an alignment marker 120 and an undesirable noise (vibration) attenuation device 130, which is close to the interface with the SSM 11.

The telescopic-type SPM 100 also has an intervention panel 170 preferably by ROV, at its upper end, which contains connectors suitable for connection by ROV, parking positions for connector covers and ROV anchoring devices, in addition of internal electrical cabling 140, which connects the panel 170 to the SSM 11, a support and alignment device 160 of equipment such as the Positioning and Alignment Module (PAM), and also a head 910 A, located on the upper flat face of the SPM 100, which receives the electrical, hydraulic and signal functions from the ROV, after quick coupling with the same. For simplicity, the present description assumes that the subsea support vehicle is an ROV, although it is not limited in such a way.

Alternative configurations, including the use of other devices to assist in the installation and use of the SPMs 100 described herein, are possible, without departing from the scope of the present invention. Such variations will be readily realized by the technician skilled on the subject for specific applications.

### 1.1.2.1 Burial Method of the Telescopic-Type SPM

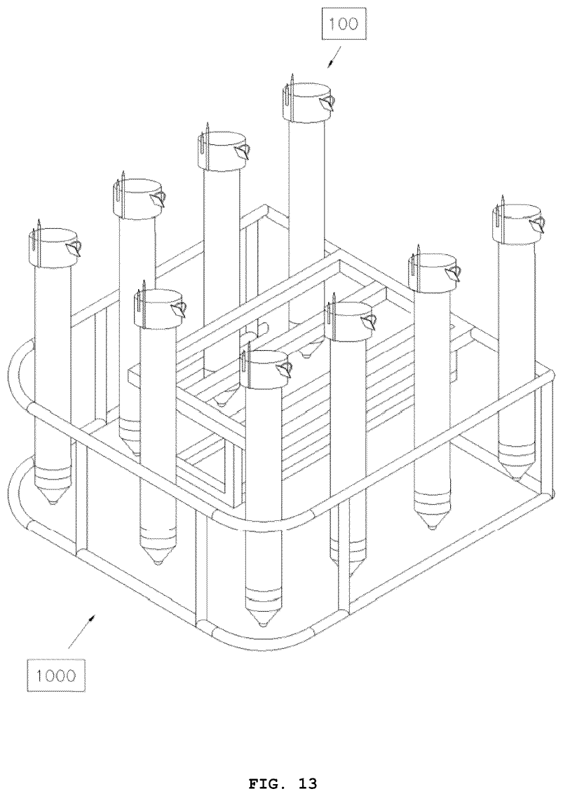

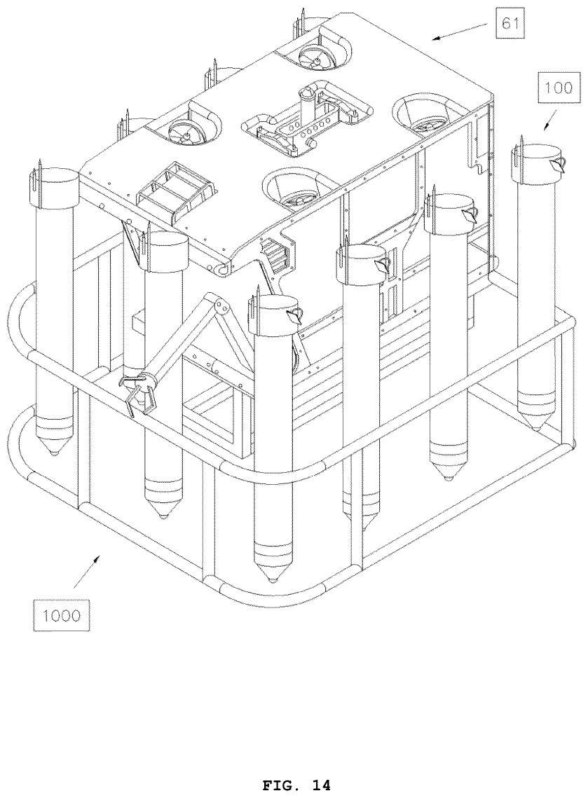

In the case of the need to bury receiving piles with precise positioning on the seabed, the use of a controlled and active burial mechanism is required, with operation and installation supported by subsea vehicles, for example an ROV, wherein the auxiliary device that allows such procedures to be carried out is called “Cartridge” 1000, as seen in FIGS. 13 and 14. Such an auxiliary device, adaptable to an ROV 61, is shaped like a crate, and operates as a loading and transport device for several units of SPM 100 on each ROV descent operation.

Once the Cartridge 1000, coupled to an ROV 61, is loaded with a quantity of SPMs 100, in a compacted configuration, compatible with its capacity, and the support vessel is positioned above the installation point on the seabed, the assembly is lowered to the point with pre-defined coordinates for installation, on the seabed, where the ROV arm removes an SPM 100, and begins to pile the same in the marine substrate thanks to a mechanism that generates a differential of pressure created from the ROV's own hydraulic system, as described in detail below. In this embodiment of burial, and with due monitoring and remote control of the subsea operation, the SPM 100 can be buried to the desired length, thus eliminating the need to incorporate elements such as the burial restrictor device 15, required for adequate burial of the torpedo-type SPM 10. Depending on the depth to the seabed, it may be more advantageous in terms of productivity to keep the set “Cartridge” plus ROV submerged while the vessel heads to the next installation position. After installing all the SPMs 100 transported in the “Cartridge”, the assembly is brought back to the vessel, and a new installation procedure begins, at another pre-determined installation point, until all the SPMs 100, scheduled to be used during seismic survey, are installed.

### 1.2 Seismic Sensor Module (SSM)

Referring to FIG. 3, the Seismic Sensor Module (SSM) 11 encompasses the sensors that effectively measure the seismic vibrations. The state of the art teaches that different sets of sensors can be used to fulfill this function. The SSM 11 of the present invention is preferably constituted by a triaxial block of “vector” seismic sensors 31 that can be geophones (for measuring particle velocity according to three mutually orthogonal axes) or accelerometers (for measuring particle acceleration, according to three mutually orthogonal axes), complemented by a fourth seismic sensor, “scalar” 32, co-located, represented by a hydrophone (for measuring pressure waves), composing a set of multicomponent seismic receivers. Each of these four sensors is in contact with an interface 34 that separates them from the external environment. The seismic sensors are conveniently located at the lower part of the SSM so that they receive the seismic excitation from the subsurface with minimal effect or interference from propagation along the SPM 10, 100. The SSM 11 also contains at least two inclination sensors or inclinometers, included in a block of sensors 33, capable of measuring the inclination according to at least two orthogonal axes, and a pressure vessel containing the conditioning and control electronics 35. The SSM 11 is mounted jointly to the base of the SPM, either of the torpedo type 10 or telescopic type 100, so that it is buried and in direct contact with the marine substrate.

Sensors such as geophones, accelerometers, hydrophones and inclination, used by the present invention, are widely known in the state of the art and will not be detailed herein. The present invention contemplates the use of any quantity of any of these sensors without departing from its scope. Although the use of these sensors is known in the art, the geometry of the SSM 11 and the way in which this module is integrated with the SPMs 10, 100, according to joint but distinct modules, are specific to the present invention. If desired, it is possible to use additional sensors without departing from the scope of the present invention. For example, a specific application may use, without limitation, a temperature and/or gravimetry sensor.

The SSM 11 preferably further has alignment pins 36 to allow the transfer of the attitude and directions of the “vector” seismic sensors to the top of the SPM 10, 100.

Now making joint reference to FIGS. 1, 2 and 3, the communication between the SSM 11 and the SPM 10, 100 takes place through connections 37 and 38 and electrical cables 14, 140 (located inside the SPM 10, 100), which extend to the panel 17, 170 of connectors suitable for connection by ROV, located at the upper end of the SPM 10, 100.

### 1.3 Subsea Seismic Data Acquisition Module (SSDAM)

As illustrated in FIG. 4, the System, according to the first aspect of the present invention, also includes a Subsea Seismic Data Acquisition Module (SSDAM) 41. The SSDAM 41 includes a pressure vessel preferably surrounded by a casing or buoyancy collar 47, externally attached, composed of material that reduces the immersed weight, for example, a syntactic foam, but not limited to just this material. Internally, the SSDAM 41 further includes control electronics to control its functions, a high-stability time measuring system for the temporal synchronization of the recorded seismic signal samples, a high-density non-volatile memory for storing seismic data, a transducer of the acoustic modem 43 for communication with the ROV or a surface ship, and batteries for electrical supply to the SSDAM 41 and SSM 11. The components located on the outside of the SSDAM 41 include a support 42 for handling and transport by ROV, at least one electrical connector 44, at least one cable 45, and at least one wet connection connector 46, for coupling to the panel 17, 170 of the upper end of the SPM 10, 100. Optionally, the SSDAM 41 may have a dry cable and connector for connection to SCM (not shown).

The SSDAM 41 allows configuration, calibration, activation, testing and data recovery through dry (direct) connection to the SCM and/or remote communication with this SCM via acoustic modem, which applies to both the case of the Torpedo-type SPM 10 and the Telescopic-type SPM 100. The initialization forms and duration of signal recording by SSDAM are programmable. The SSDAM may have a plurality of cables 45 and wet-connect connectors 46 to be connected to one or several SPMs 10, 100 to minimize ROV usage time, which implies a lower cost for connection and disconnection operations of the modules.

The Surface Control Module (SCM), not shown, subsequently, and already on board the support vessel, communicates with the SSDAM 41 to collect the acquired seismic data. Any apparatus suitable for this purpose can be used in the SCM of the present invention. In a non-limiting example, the SCM may consist of a computer and programs installed thereon, acoustic modem, interfaces and connections necessary to electrically power and communicate with the SSDAM 41, either by direct, dry connection, or remotely, through the acoustic modem installed on the support vessel or installed on the ROV, in this case using communication resources from the ROV umbilical.

### 1.4 Positioning and Alignment Module (PAM)

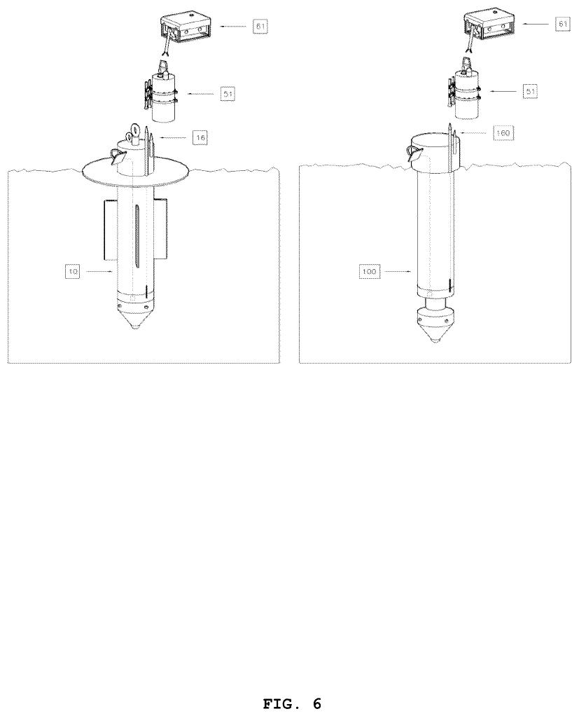

As illustrated in FIG. 5, the Positioning and Alignment Module (PAM) 51 consists of subsea equipment with positioning and acoustic communication functions, containing precision attitude and true heading sensors, batteries and data recording means. At a moment subsequent to piling the SPM 10, 100, a PAM 51 is inserted into an alignment receptacle, located at the upper end of each SPM 10, 100, through the respective support and alignment devices 16, 160, to allow the accurate determination its attitude and position, as seen in FIG. 6. The PAM 51 uses the ROV support bracket 52 and the transducer of the modem and acoustic transponder 53. This module is inserted by ROV into a support 16, 160 aligned on the SPM 10, 100, by the double funnel method of different heights, through a coupling device 54. Advantageously, obtaining the accurate spatial coordinates (x, y, z) and heading (azimuth) of the SPM 10, 100 or, ultimately, of the seismic receivers 34 contained in the SSM 11 that is joint to the same, through the PAM 51, can be carried out only once throughout the entire seismic monitoring project, after the piling of the various units of SPM 10, 100, in the form of a dedicated geodetic service. Of course, new coordinate acquisitions can be made later as desired or if considered necessary.

### 1.5 Integration Between the Modules and System Operation

Below, the connection scheme for the modules of the Permanent Seismic Monitoring System will be described in detail, in accordance with the first aspect of the invention.

FIG. 6 represents the physical connection between the PAM 51 and the SPM 10, 100, with the aid of a subsea vehicle, preferably an ROV 61, but which may be another type of vehicle or means capable of carrying out such engage operation.

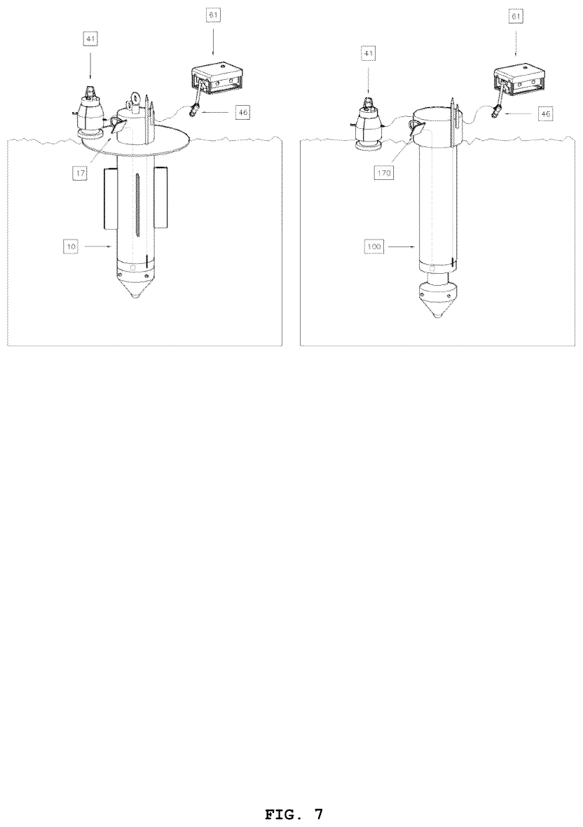

FIG. 7 illustrates the connection of SPM 10, 100 to SSDAM 41 (not shown here in detail, for simplicity) for collecting seismic data. The SSDAM 41 is transported to a suitable location for connection to one or more SPMs 10, 100, where the at least one wet connection connector 46 of the SSDAM 41 is handled by the ROV 61 and coupled to the panel 17, 170 located on the upper part of the SPM 10, 100. Optionally, multiple wet connectors 46 originating from a single SSDAM may each be coupled to the panel 17, 170 of multiple corresponding SPMs 10,100, for the purpose of minimizing ROV operations. Optionally, an individual SSDAM 41 is carried and connected to each SPM 10, 100. Optionally, and only for the case of the SPM 10, the SSDAM 41 is supported by the burial restrictor device 15, while the connection is maintained (as illustrated in FIG. 7). Through the connection between connector 46 of the SSDAM 41 and the panel 17, 170, the sensors of the SSM 11 are energized and enabled to transmit data to the SSDAM 41, which stores the same, for example, in the memory.

After all the one or more SSDAMs 41 are connected to the corresponding SPMs 10, 100, the acquisition of seismic data begins, for example, with the detonation of multiple shots throughout the survey area or any other means considered suitable for surveying seismic data. Once the data survey is complete, the one or more SSDAMs 41 are then disconnected, recovered by the ROV 61 and brought to the surface, where the seismic data files are transmitted to the SCM.

The lifting, transportation, descent to the seabed and ascent of SSDAM 41 to the surface, for handling and installation by ROV 61 next to SPMs 10, 100, can be carried out by an auxiliary basket, lifted by a crane. However, other means of transporting SSDAMS 41 are contemplated by the present invention without departing from the scope disclosed herein.

The advantages of the above connection scheme will be evident to a technician skilled on the subject. Since the sensors of the SSM 11 are powered by the SSDAM 41, which is non-permanent, there is no need for batteries internal to the SPM 10, 100, eliminating the prior art problem of having to periodically change the units, which contain the batteries that power the sensors, which adds value in terms 41 cost, operational accuracy and data integrity. Advantageously, this innovation, combined with the fixed and permanent position of the SPMs 10, 100, enables a Permanent Marine Seismic Monitoring System with a high degree of repeatability and which requires minimal maintenance. Since the SPMs 10, 100 do not need to be removed to collect seismic data, the operational cost of this procedure and the inaccuracy related to future repositioning are eliminated.

Another advantage achieved by the Permanent Marine Seismic Monitoring System of the present invention is the reduction in total data processing time, with faster delivery of the final products derived from the acquired seismic data, and, consequently, the results of their analysis, since the positions of the receivers are already known, and do not vary with each new seismic survey.

At any time after the piling of each SPM 10, 100, a precision long-baseline acoustic positioning campaign is optionally carried out, through a dedicated geodetic service, for each installed SPM 10, 100. In this type of survey, a network of reference transponders is installed on the seabed, using, whenever possible, notable points or subsea production equipment, and previously known spatial coordinates. The network must be calibrated and must have well-defined cartographic references for use in the area.

With reference to FIG. 6, with the aid of the ROV 61, the PAMs 51 are inserted and aligned at the top of the various SPMs 10, 100 through the respective support and alignment devices 16, 160, and become geodesic polygonal vertices, whose acoustic measurements allow accurate adjustments and estimates of the positions of all the SPMs 10, 100.

As, in the case of the torpedo-type SPM 10, it is not possible to guarantee that the SPM 10 will be perfectly vertically piled, and it may even incline due to the subsequent landslide, (which can also occur for the SPM 100), the inclination sensors of the sensor block 33 act to allow the correction of the seismic measurements, by applying appropriate rotations in the processing step of the recorded data. It is further necessary to determine the true directions (azimuths) of the seismic sensor axes. This determination is performed by the PAMs 51, once inserted into the support and alignment device 16, 160 and aligned to the SSM 11, more specifically to the longitudinal component of the horizontal geophone or horizontal accelerometer. This alignment is marked on the external side face of the SPM 10, 100 by a rectilinear frieze 12, 120 disposed in the downward continuation of the axis of the support and alignment device 16, 160.

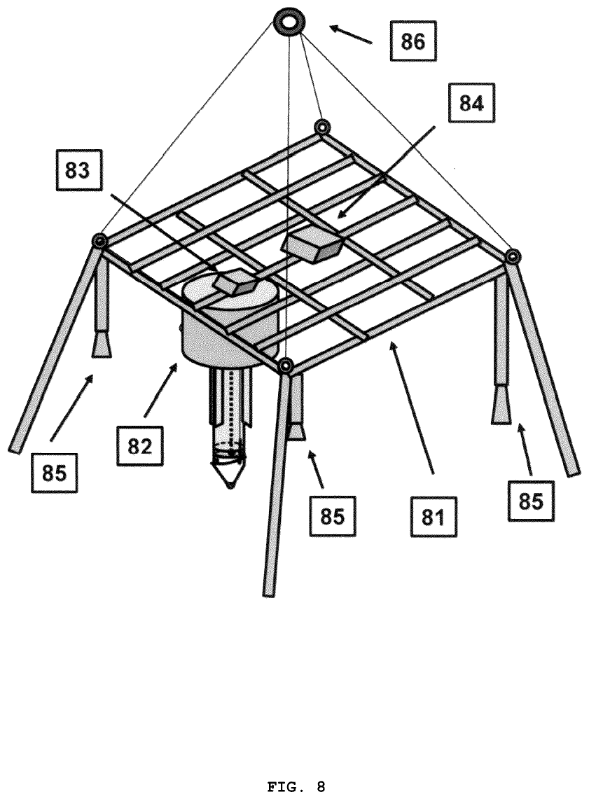

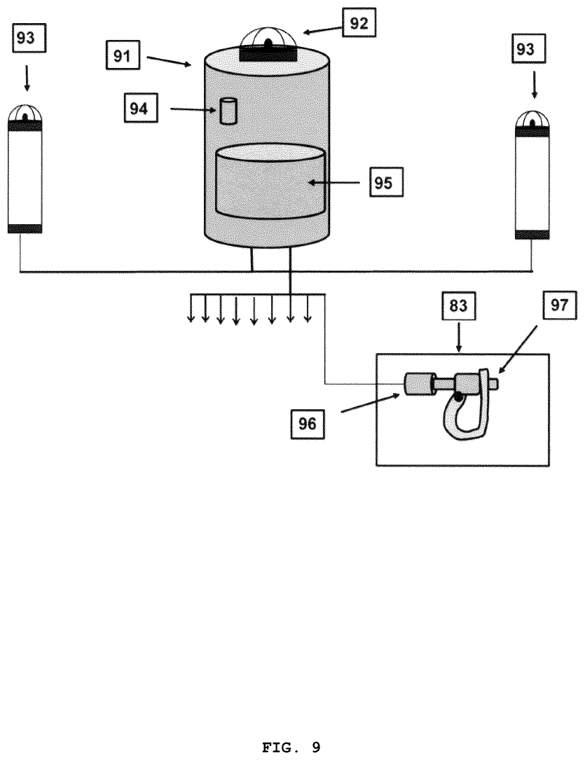

FIGS. 8 and 9 illustrate the preferred equipment and methods for transporting and releasing the Torpedo-type SPMs 10.

As seen in FIG. 8, the Pile Transport and Release Device (PTRD) 81 allows up to nine Torpedo-type SPMs 10 to be accommodated, suspended in the vertical position, in lifting, subsea transport and descent operations to the desired depth, where the Piles are released so that they assume a free-fall movement and be piled into the marine substrate. The PTRD 81 is a structure that can be lifted by an onboard crane using a sling 86, and is capable of supporting nine vertical cylinders 82. The Torpedo-type SPMs 10 are accommodated in these vertical cylinders 82 so that they remain immobile during the transport, the vertical cylinders 82 being sized to contain the burial restrictor device 15. Within each vertical cylinder 82, the Torpedo-type SPM 10 is suspended by its supporting eye 19, in turn engaged with a release mechanism 83 that is located just above the crosslink of the PTRD 81. Each release mechanism unit 83 is connected to the Subsea Auxiliary Control Mechanism 84, which is unique to the entire assembly. The PTRD 81 further contains 3 vertical alignment funnels 85, mounted on the vertices of its crosslink.

FIG. 9 details the Subsea Auxiliary Control Mechanism 84. This consists of control electronics, located in a pressure vessel 91, acoustic modem 92, inertial unit for measuring angular and linear movements and heading 94, and internal batteries 95. Remote acoustic positioning transponders 93 are further installed on diagonal upper vertices of the PTRD 81. The Subsea Auxiliary Control Mechanism 84 acts as a central command for the various release mechanisms 83, each located on top of the respective vertical cylinder 82 that supports every 10 SPM. According to the same FIG. 9, each release mechanism 83 contains an electric actuator 96 and a pull-open release hook 97 to release each SPM 10 into the water, wherein the supporting eye 19 of the SPM 10 is suspended by this release hook 97.

The Subsea Auxiliary Control Mechanism 84 is activated from the surface by acoustic link through the acoustic modem 92. From such acoustic command, coming from the surface, each SPM 10 is released, through the actuation of the electric actuator 96, which moves the release pin of the hook 97, which in turn secures the supporting eye 19 at the top of the SPM 10. The release hook 97 is such that it has features that allow it to be easily actuated under traction related to the weight of the SPM 10.

Regarding operation, the SPMs 10 are lifted by an onboard crane, through its lifting eye 18, and inserted vertically into a jig that keeps them fixed and aligned. The PTRD 81 is lifted and engaged over this jig by using alignment funnels 85, which ensures the placement of the supporting eyes 19 of the SPMs 10 in the closing position of the release hooks, and its loading onto the anchor handling vessel.

In the case of the SPMs 10, the vessel is positioned above the desired position, and the PTRD 81 is lowered to the required depth, over each pre-defined installation point, guided by acoustic measurements of its position, as well as its own movements. The acoustic command is then triggered to release the SPM 10 and, subsequently, the PTRD 81 is displaced to the next installation position. These operations are repeated until all the SPMs 10 are installed.

The SPM 10 are installed on the marine substrate by using the usual procedure of releasing torpedo piles, used as foundations of oil structures, in free fall, as is known in the art. When released, the SPMs 10 move in free fall to the seabed, where they are piled due to their own weight and shape, and the burial restrictor device 15 ensures that the burial of the SPM 10 does not exceed the desired length. Optionally, the SPM 10 may contain side fins 20 to assist in maintaining the trajectory to the seabed.

The second aspect of the invention will next be described, namely, another way of installing the seismic sensors, which includes the Telescopic-type SPMs 100, installed by subsea vehicles. This aspect is aimed at cases in which the torpedo-type SPM 10 and its piling method, as previously described, are inadequate or unfeasible, due to the presence of operational obstacles on the seabed or in environmentally sensitive areas. These obstacles can be, for example, locations at the bottom where there are already facilities or infrastructure in operation, such as flow pipes and other production equipment. On the other hand, areas that are of interest and environmental sensitivity may include, for example, places with the presence of biogenic features, such as corals or rhodoliths.

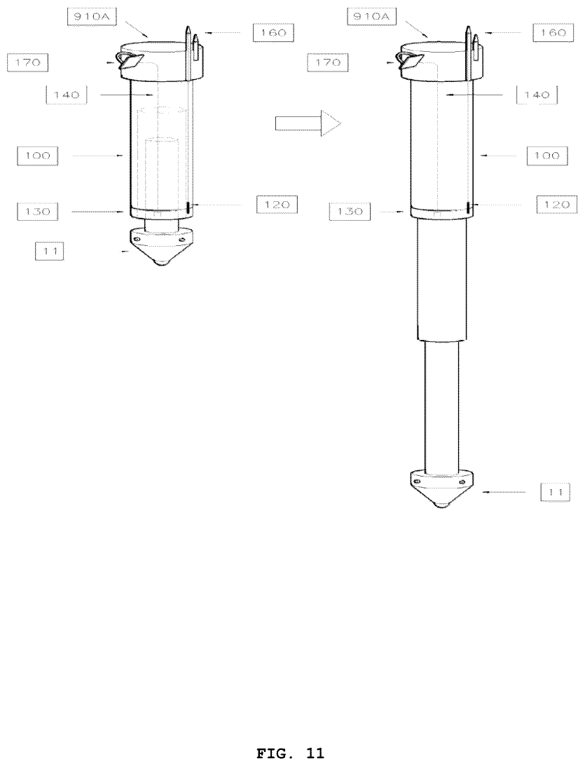

To address to such issues, thus ensuring operational safety and the integrity of the marine environment, another technological route was conducted, based on a Telescopic-type pile, as exemplified in FIGS. 2 and 11. The telescopic-type SPM 100 consists of at least two cylindrical sections aligned along the same central geometric axis, wherein the first cylindrical section, that is, the uppermost cylindrical section, counted from the upper end of the SPM 100, and the second cylindrical section, that is, the cylindrical section following the first, counted from the upper end of the SPM 100, have diameters such that the second cylindrical section can slide and be inserted inside the first cylindrical section in a tight manner. In the case of a greater number of sections, each cylindrical section has a diameter such that it can slide and be inserted inside the immediately superior cylindrical section in a tight manner. In this way, the SPM 100 can assume two different basic configurations (FIG. 11): an extended configuration (used for installation/burial), where its exposed cylindrical sections are aligned according to a central geometric axis, and a compacted or collapsed configuration (used for storage and transport), wherein each cylindrical section is slid and inserted into the immediately superior cylindrical section in a tight manner, so that all cylindrical sections become concentric. Thus, the SPM 100 disclosed herein can be compacted to occupy less space during storage and transport, facilitating operational logistics.

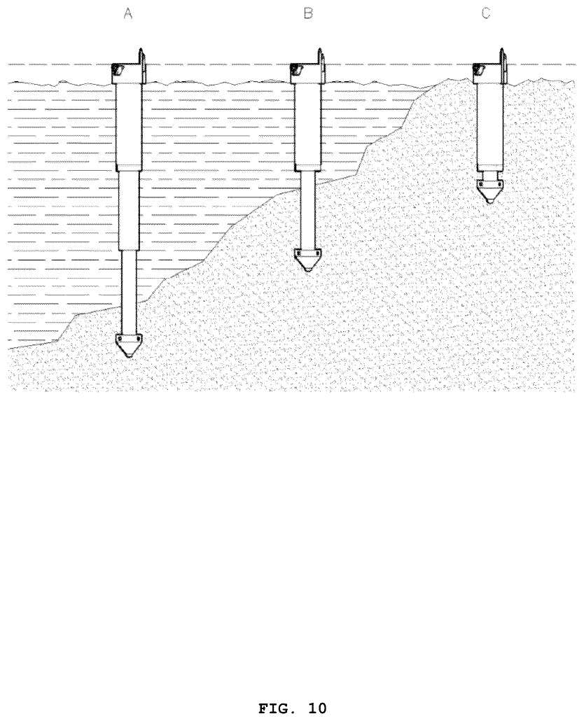

The number and length of the cylindrical sections are chosen according to the application and characteristics of the marine substrate where they will be buried (as they need to be well anchored therein), but the total length, considering the extended configuration, is typically of the same order as the torpedo-type SPM 10, that is, between 3 and 4 m, which can be greater depending on the needs of specific applications, as will be seen later. For example, for applications where a large burial depth is not required, due to the greater degree of consolidation of the shallower substrate, the SPM 100 can enclose a smaller number of cylindrical sections, for example, two cylindrical sections. On the other hand, in applications where a greater burial depth is desired or necessary, due to the lower degree of consolidation of the shallower substrate, the SPM 100 can enclose a greater number of cylindrical sections, for example, three or more sections, and eventually, in this case, the total length in the extended configuration may exceed that typically used. The number of cylindrical sections is therefore suited to the specific needs of each application, technical criteria and transport capacity. For example, as represented in FIG. 10, a marine substrate can contain different layers, with laterally variable constitution, thickness and degrees of consolidation, which can give rise to the use of different quantities of cylindrical sections for the SPM 100 in different positions (labeled as “A”, “B” and “C” in FIG. 10), and, thus, different mechanical compositions, different pressurization levels of the burial assembly, and different total lengths in the extended configuration.

The upper cylindrical section additionally has a head 910 A (FIGS. 2 and 11) that acts as a suitable element for quick coupling, which is hydraulically energized by a hydraulic unit of the ROV 61, which will be described later. For example, and preferably, such a head 910 A may be a hole situated in the upper face of the upper cylindrical section for engagement with a hydraulic hose of the hydraulic system of the ROV 61. However, the invention is not limited to this preferred engagement element, which can assume other configurations without departing from the scope of the present invention.

Advantageously, the SPM 100 is capable of meeting the need for a sensor burial depth of just a few meters (for example, between 3 and 4 m), which can be crucial in certain applications such as those described previously, as well as being able to meet the need for greater burial depths (for example, above 4 m), if desired, thus presenting flexibility of use.

The SPM 100 can be manufactured with lightweight materials that are easier to handle compared to the materials required to manufacture the Torpedo-type SPM 10. As described below, the piling of the SPM 100 into the marine substrate, according to the present invention, is done in a smoother and more controlled manner, such that the structure does not need to have the high impact strength of the SPM 10, which is installed from of free fall movement. For example, the SPM 100 can be manufactured with materials based on light alloy metals, polymeric composition items, carbon fiber and engineering plastics, such as acetal, without being limited to these. Any other materials that are considered suitable for the subsea operation may be used, without departing from the scope disclosed herein.

Advantageously, the lighter material, combined with the smaller volume, additionally reduces the operating costs of the SPM 100, due to the possibility of transporting a greater number of SPMs 100 in a single descent, due to the reduced weight and dimensions.

The telescopic-type SPM 100 has, essentially, the same electromechanical structure and architecture as the Torpedo-type SPM 10, already shown previously. At its lower end, that is, in its last cylindrical section, the SPM 100 contains a noise (vibration) attenuation device 130, and is jointly coupled to a Seismic Sensor Module (SSM) 11, and, at the upper end, contains a panel 170 for connection to the SSDAM 41. An exclusive element of the SPM 100 is a head 910 A, located on its upper face (FIG. 2), for quick coupling with the ROV hose. With the exception of the burial restrictor device 15, the lifting 18 and supporting 19 eyes, and the side fins 20 (unnecessary elements in the case of the SPM 100), the components are preferably the same as those described previously and illustrated in FIG. 1; so, they will not be described here again. The same applies with respect to FIGS. 3, 4, and 5, which illustrate System modules that are interchangeably used in conjunction with both types of SPMs 10, 100. While the torpedo-type SPM 10 is designed in shape and weight to allow its piling at the desired depth in the marine substrate after descending in a free fall movement, the telescopic-type SPM 100, due to the fact that its burial in the marine substrate is done in loco and in a controlled manner, is exempt from meeting requirements of weight, which makes the choice of constituent material more flexible and facilitates its operational handling. Due to this same burial concept, the use of the PTRD 81 becomes unnecessary for the installation of the SPM 100.

The method of installing the SPM 100 will now be described. As will be seen, this method, combined with the advantageous configuration of the SPM 100 of the telescopic-type described previously, makes it possible to implement a permanent subsea seismic monitoring system with point receivers in regions of high bottom complexity, where it would not be recommended, in the name of good operational and environmental safety practices, to use the torpedo-type SPM 10, for example, areas where there are already installations in operation, such as flow pipes and other equipment of production, or even areas with very variable and irregular bathymetry and topography, or that present environmental interest and sensitivity, such as seabeds with the presence of corals or rhodoliths.

The SPM 100 is positioned on the seabed with the aid of a subsea vehicle, such as an ROV 61, as previously described. Optionally, an autonomous underwater vehicle (AUV) or other suitable equipment may be used to carry out the steps of the installation and positioning method described herein, without departing from the scope of the invention. For simplicity, the steps of the method will be described considering that this equipment is an ROV 61, described previously, and is not limited to the same.

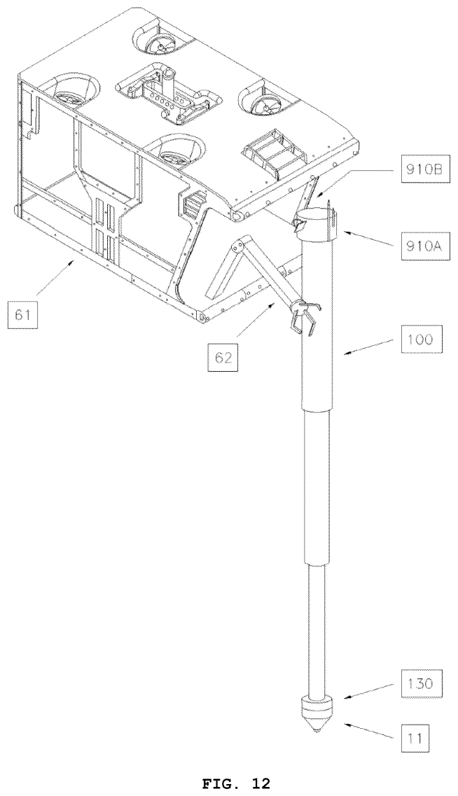

With reference to FIG. 12, in which the “Cartridge” is omitted for simplicity, the ROV 61 transports the SPM 100 in its compacted (collapsed) configuration to the designated location for piling, and positions the same, for example, by means of a mechanical arm 62 operated remotely or automatically. When the SPM 100 is in the desired spatial position (geographical coordinates), a pumping assembly is activated on board the ROV 61, in order to create a pressure differential between the fluid inside the SPM 100 and the fluid outside (sea water), enough to result in the introduction of one or more of the cylindrical sections of the SPM 100 into the marine substrate. In other words, it is this pressure differential, which in this case is the ratio between the applied force and the area of action of that force (which is the flat face 910 A of the SPM 100, whose internal section slides under the external section) which promotes the displacement of the cylindrical sections of the SPM 100, changing its initial compacted configuration to the extended configuration (FIG. 11). As the SPM 100 is positioned vertically, upright and directed downwards, this sliding between the sections will force the penetration into the substrate, and the introduction of the lower cylindrical section of the SPM 100 plus the basal cone (SSM 11) that contains the sensors. Therefore, the SPM 100 is installed so that it is partially buried in the marine substrate in its extended configuration.

This pressure differential is preferably created by a hydraulic unit, already normally installed in ROVs used in subsea operations, as is already known in the art. Such a hydraulic unit generally consists of a motor, a pump and an oil reservoir, this assembly being enclosed in a tight container. This assembly acts as the pressure differential generating mechanism described above. The function of the hydraulic unit is to provide hydraulic energy for the operation of any tool that is used on the seabed. Preferably, the hydraulic socket feeds the head 910 A, located on the upper flat face of the SPM 100 (FIG. 12), which, through quick coupling with its counterpart 910 B, in turn installed in the ROV-Cartridge assembly (which will be described in details later), allows the transfer of electrical, hydraulic and signal functions to drive the SPM 100. Such an interface for quick coupling 910 B (FIG. 12), which directly receives the functionalities of the ROV 61 to transfer the same to the SPM 100, is not a standard component of such a vehicle, needing to be incorporated into the same whenever it has the specific mission of carrying out the burial of SPMs 100. The present invention, however, is not restricted to such a vehicle or mechanism, and any equipment capable of generating this pressure differential can be used, without departing from the scope disclosed herein. For example, if desired for a specific application, equipment capable of generating a pressure differential may be external and separate from the ROV 61.

As previously mentioned, the installation method described herein is advantageous for being smoother and more precise than the method based on free fall, meaning that the SPM 100 can be manufactured with materials with lower impact strength and lighter weight, reducing its weight (in addition to the lower storage and transport space requirement, in its collapsed configuration) and consequently the operating costs. This also applies to the impact on the sensors embedded in the SSM 11, which is significantly reduced.

Another advantage of this method is obtaining burial precisely in the desired position, with a greatly reduced risk of mechanical damage to the bottom installations that may exist nearby, thus improving the operational safety thereof.

Another advantage of this method is the minimal impact on the marine environment, allowing the installation of the Permanent Subsea Seismic Monitoring System in areas of environmental sensitivity, such as regions with the presence of corals or rhodoliths.

Yet another advantage of the method described herein is the guarantee that the SPM 100 is installed not only in very well-known spatial coordinates, but also in the most vertical way possible, so that the need to use a Positioning and Alignment Module (PAM) is greatly reduced or eliminated.

Advantageously, the SPM 100 can be more or less deeply buried in the marine substrate, depending on the rigidity of the sediments that compose the same, as illustrated in FIG. 10. If desired or necessary, the pressure differential can be chosen in such a way that fewer than the total number of cylindrical sections are buried in the seabed. For example, only one of the cylindrical sections, in this case, the lower cylindrical section, jointly connected to the SSM 11, can be buried, for example, in the case in which the most superficial layer of the substrate already provides sufficient support to the SPM 100, while the other cylindrical sections remain above the seabed.

Once the SPM 100 is installed, the method of obtaining seismic data is equivalent to what was described in relation to the Torpedo-type SPM 10, illustrated in FIG. 7, which shows the connection of the SPM 10, 100 to the SSDAM 41 (not shown in detail, for simplicity) for collecting the seismic data, except that for SPM 100, SSDAM 41 cannot be supported on the burial restrictor disk 15, absent in this type of SPM. The SSDAM 41 is transported to a suitable location for connection to one or more SPMs 100, where at least one wet connection connector 46 of the SSDAM 41 is handled by the ROV 61 (or by another type of vehicle or means capable of performing such a connection operation) and coupled to the panel 170 located on the upper part of the SPM 100. Optionally, if a single SSDAM 41 is used for a certain number of SPMs 100, for the purpose of reducing ROV operations, multiple wet connectors 46 can be coupled, each, to the panel 170 of corresponding multiple SPMs 100. Optionally, an individual SSDAM 41 is transported and connected to each SPM 100. Through this connection, the sensors of the SSM 11 are energized and enabled to transmit data to the SSDAM 41, which stores the same, for example, in the memory.

After all the SSDAMs 41 are connected to the corresponding SPMs 100, the acquisition of seismic data begins with the detonation of multiple shots throughout the survey area, or any other means that is considered suitable for surveying seismic data. Once data acquisition is complete, the SSDAMs 41 are then disconnected and recovered by the ROV 61 and brought to the surface, where the seismic data files are transmitted to the Surface Control Module (SCM). Briefly, the SSDAM 41 is transported to the installation point of one or more SPMs 100, and has at least one wet connection connector 46 connected to the panel 170 of at least one SPM 100. During surveying, the seismic waves are generated and captured, after interacting with the subsurface, by the sensors of the SSM 11, which are energized by the internal battery of the SSDAM 41 through the connection of the wet connection connector 46 to the panel 170. Next, the sensors of the SSM 11 send their data to the SSDAM 41 through the connection the wet connection connector 46 to the panel 170, and the SSDAM 41 preferably stores the same in a memory. After completing data collection on each SPM 100, each SSDAM 41 is disconnected and transported back to the surface, where the stored data is transferred to the SCM.

In order to make better use of resources, and to take advantage of and increase the efficiency of operations with the ROV 61 and, consequently, of the support vessels that launch the same, it is also provided for to employ an auxiliary mechanism adaptable to an ROV, in the shape of a crate, called “Cartridge”, which operates as a transport device for the SPMs 100, which is capable of carrying and assisting in the handling and piling of several units in each ROV descent operation, as illustrated in the FIG. 13. One or more of these devices, in the shape of a crate, can be previously placed at predetermined points on the seabed, where they will reside, so that they serve areas within the radius of action of the ROV 61, thus minimizing the number of descents and raising of the ROVs, aiming at optimizing the operations.

Advantageously, the use of “crates” coupled to the ROV 61, as illustrated in FIG. 14, contributes to further reducing operational costs related to the multiple missions that would be necessary in the prior art.

### 1.6 Method of Unearthing (Removing) the Telescopic-Type SPM 100

Still advantageous in relation to other methods of piling and removal in marine soil, and aligned with the most recent demands and corresponding decommissioning requirements, there is the possibility of applying the controlled burial methodology of the SPM 100 above described inversely, so that, at the end of the long-term seismic monitoring project, or, conveniently, under specific demands, during the seismic project—for example due to determinations from environmental agencies—the SPMs 100 can be removed, freeing the seabed of such items and leaving it as it was before installation.

For example, the ROV 61 approaches the SPM 100 to be removed and couples the quick coupling interface 910 B to the head 910 A of the SPM 100 with the aid of its mechanical arm. The previously-mentioned pressure differential generating mechanism is activated, in a similar way to that previously described for the installation method of the SPM 100; however, in this case, the pressure differential between the inside of the SPM 100 and the water outside the SPM 100 is such that the pressure from the water column moves at least two cylindrical sections of the SPM 100 upward, forcing the SPM 100 to assume its compacted configuration and removing, in a controlled manner, the SPM 100 from the marine substrate until the SPM 100 is completely unearthed. The ROV 61 then suspends the SPM 100 above the point where it was installed, by means of its arm 62, storing the SPM 100 in the Cartridge 1000. After removing the desired number of SPMs 100, the ROV 61 transports the removed SPMs 100, in a compacted configuration, to the support vessel, on the surface.

Although aspects of the present disclosure may be susceptible to various modifications and alternative forms, specific embodiments have been shown, by way of example, in the drawings, and have been described in detail in this document. But it should be understood that the invention is not intended to be limited to the particular disclosed forms. Instead, the invention must encompass all modifications, equivalents and alternatives pertinent to the scope of the invention, as defined by the following attached claims.

What is claimed is:

1. A Support-Pile Module (SPM) for subsea seismic monitoring, comprising:
a cylindrical shaped body;
a lower end to which a basal cone constituting a Seismic Sensor Module (SSM) is jointly mounted;
a support and alignment device aligned with an alignment marker;
a noise attenuation device; and
a panel for wet connection.

2. The Support-Pile Module (SPM) according to claim 1, further comprising one or more of: a burial restrictor device, multiple side fins, a lifting eye, and a supporting eye.

3. A Support-Pile Module (SPM) for subsea seismic monitoring, comprising:
at least two cylindrical sections, each comprising an upper cylindrical section and a lower cylindrical section, each cylindrical section having a diameter such that each cylindrical section, with the exception of the upper cylindrical section, can be tightly slid and inserted into the interior of the next upper cylindrical section, wherein the SPM has an extended configuration in which the at least two cylindrical sections are aligned along the same central geometric axis and are exposed along its entire length, and a compacted configuration wherein each cylindrical section, with the exception of the uppermost cylindrical section, is tightly inserted into the interior of the next upper cylindrical section, such that all cylindrical sections become co-located;
a basal cone jointly mounted on the lower cylindrical section, the basal cone constituting a Seismic Sensor Module (SSM);
a support and alignment device, aligned with an alignment marker;
a noise attenuation device housed in the base of the lowest cylindrical section;
a panel for wet connection near its upper end; and
one head.

4. A Seismic Sensor Module (SSM) for use integrated with the Support-Pile Module as defined in claim 3, comprising:
a triaxial block of seismic sensors consisting of three particle velocity sensors or three particle acceleration sensors arranged in three mutually orthogonal directions, the triaxial block being co-located with a seismic sensor sensitive to variations in pressure, the SSM further comprising at least one pair of inclination sensors capable of measuring along at least two orthogonal axes.

5. A method of installing the SPM as defined in claim 3, comprising the steps of:
a) positioning the SPM above the designated installation point for burial in a compacted configuration; and
b) activation of a pressure differential generating mechanism in order to generate a pressure differential between the interior of the SPM and the seawater outside the SPM, in order to displace the cylindrical sections of the SPM, changing its configuration to the extended configuration and partially burying the SPM in the marine substrate until it reaches a specified piling depth.

6. The method according to claim 5, further comprising, before step (a), the step of:
transporting the SPM in a compacted configuration to the designated installation point, by means of a subsea vehicle.

7. The method according to claim 6, wherein the subsea vehicle transports at least one SPM to each designated installation point in a cartridge.

8. The method according to claim 6, wherein the subsea vehicle is preferably an ROV.

9. A seismic survey method, comprising the steps of:
a) connecting at least one wet-connect connector of a Subsea Seismic Data Acquisition Module (SSDAM) to each wet connection panel of at least one SPM as defined in claim 3;
b) energizing the sensors of each SSM of each of at least one SPM by means of one or more batteries located in the SSDAM;
c) generation of seismic waves;
d) obtaining seismic data through the sensors;
e) transmission of data obtained by the sensors to a memory located in the SSDAM; and
f) disconnecting each wet connection connector from each panel.

10. The method according to claim 9, further comprising the step of:
g) downloading seismic data recorded in SSDAM on board a support vessel, to a Surface Control Module (SCM) for external recording purposes.

11. The method according to claim 9, wherein the connection and disconnection between the at least one wet connection connector and at least one or more of each panel is performed by a subsea vehicle.

12. The method according to claim 11, wherein the subsea vehicle is preferably an ROV.

13. A Permanent Marine Seismic Monitoring System, comprising:
at least one SPM as defined in claim 3; and
a Subsea Seismic Data Acquisition Module (SSDAM), wherein the SSDAM contains a clock for accurate time synchronization, one or more batteries for energizing each Seismic Sensor Module (SSM) of each one of the at least one SPM, a memory for storing recorded seismic data, and at least one wet connector for connection to at least one panel of the at least one SPM.

14. A method of removing the SPM as defined in claim 3, comprising the steps of:
a) coupling an interface to the head of the installed SPM; and
b) activation of a pressure differential generating mechanism, in order to generate a pressure differential between the interior of the SPM and the water outside the SPM, so as to displace the at least two cylindrical sections of the SPM upward until the SPM assumes a compacted configuration and removing the same from the marine substrate until it is completely unearthed.

15. The method according to claim 14, wherein the pressure differential generating mechanism is located in a subsea vehicle.

16. The method according to claim 15, further comprising the steps of:
c) storage of the SPM in a Cartridge; and
d) transporting the SPM to a surface support vessel.

17. The method according to claim 15, wherein the subsea vehicle is preferably an ROV.

18. A Seismic Sensor Module (SSM) for use integrated with the Support-Pile Module as defined in claim 1, comprising:
a triaxial block of seismic sensors consisting of three particle velocity sensors or three particle acceleration sensors arranged in three mutually orthogonal directions, the triaxial block being co-located with a seismic sensor sensitive to variations in pressure, the SSM further comprising at least one pair of inclination sensors capable of measuring along at least two orthogonal axes.

19. A seismic survey method, comprising the steps of:
a) connecting at least one wet-connect connector of a Subsea Seismic Data Acquisition Module (SSDAM) to each wet connection panel of at least one SPM as defined in claim 1;
b) energizing the sensors of each SSM of each of at least one SPM by means of one or more batteries located in the SSDAM;
c) generation of seismic waves;
d) obtaining seismic data through the sensors;
e) transmission of data obtained by the sensors to a memory located in the SSDAM; and
f) disconnecting each wet connection connector from each panel.

20. The method according to claim 19, further comprising the step of:
g) downloading seismic data recorded in SSDAM on board a support vessel, to a Surface Control Module (SCM) for external recording purposes.

21. The method according to claim 19, wherein the connection and disconnection between the at least one wet connection connector and at least one or more of each panel is performed by a subsea vehicle.

22. The method according to claim 21, wherein the subsea vehicle is preferably an ROV.

23. A Permanent Marine Seismic Monitoring System, comprising:
at least one SPM as defined in claim 1; and
a Subsea Seismic Data Acquisition Module (SSDAM), wherein the SSDAM contains a clock for accurate time synchronization, one or more batteries for energizing each Seismic Sensor Module (SSM) of each one of the at least one SPM, a memory for storing recorded seismic data, and at least one wet connector for connection to at least one panel of the at least one SPM.
